(19) United States
(12) Patent Application Publication
(10) Pub. No.: US 2025/0059338 A1
(43) Pub. Date: Feb. 20, 2025

(54) METHOD OF MAKING HIGH STRENGTH FIBER FOAM COMPOSITE

(71) Applicant: The United States of America, as represented by The Secretary of Agriculture, Washington, DC (US)

(72) Inventor: GREGORY M. GLENN, GRAND JUNCTION, CO (US)

(21) Appl. No.: 18/450,048

(22) Filed: Aug. 15, 2023

(51) Int. Cl. C08J 9/06; C08L 1/02

(52) U.S. Cl. CPC C08J 9/06; C08L 1/02; C08J 2301/02; C08J 2401/02; C08J 2403/02; C08J 2429/04

(57) ABSTRACT

A biodegradable high strength cellulosic fiber foam material is made by combining cellulosic fibers with a sodium dodecyl sulfate, polyvinyl alcohol, and starch. Paperboard reinforcing/support elements/means are embedded in the high strength cellulosic fiber foam material wet mix to increase the compressive strength and other properties when the foam is dried. The foam comprises a light weight, high strength, insulative, biodegradable material that may be used for at least packaging materials and food containers. The biodegradable fiber foam composite material has mechanical properties similar to non-biodegradable petroleum-based, expanded polystyrene, polyurethane, and other petroleum-based products.

### FIELD OF THE INVENTION

The disclosed subject matter relates to a method of making a high strength fiber foam composite material. Specifically, the subject matter described herein relates to a method of making a composite material/panel comprising a cellulosic fiber foam in combination with a paperboard matrix so that the product comprises a light weight, high strength, insulative, biodegradable material that may be used for at least packaging materials and food containers. The biodegradable fiber foam composite material has mechanical properties similar to non-biodegradable petroleum-based, expanded polystyrene, polyurethane, and other petroleum-based products.

### BACKGROUND OF THE INVENTION

The packaging and distribution of goods is a multibillion dollar business worldwide, with millions of packages being transported every day using a myriad of different package configurations. In 2022, 21.2 billion packages were shipped in the U.S.—which was 1.1 billion more than the pre-pandemic projections.

Although there is no meaningful biodegradation of commodity plastics which are mostly derived from non-renewable resources, they continue to play a major role in the packaging sector. More than 40% of the worldwide production of plastics is used for packaging, much of which is “single use”. A small percentage of plastics is reused/recycled but roughly 80% is either landfilled or leaked into the environment.

There is a growing effort to use less plastics and more renewable materials in “single-use”-type packaging where the end-of-life involves recycling or composting. Governmental legislation is increasingly mandating greater environmental accountability in the packaging industry. For example, the state of California passed a bill called “The Plastic Pollution Prevention and Packaging Producer Responsibility Act”. This legislation mandates that all single-use plastic packaging and food ware be fully recyclable or compostable by 2032.

The most successfully recycled/reused packaging material is paper and paperboard. These materials are largely made of wood pulp fiber. In 2022, the paperboard box industry was estimated to be worth $77 billion in the U.S. The EPA reported that paper and paperboard made up nearly 67% of the recycled municipal solid waste (MSW) materials in 2018. Most of the recycled paper and paperboard (96.5%) was comprised of corrugated boxes. Corrugated board is a desirable packaging material that is biodegradable, derived from renewable resources, easy to reuse/recycle and, unlike commodity plastics, will decompose if leaked into waterways or the landscape.

For many commercial products such as small appliances, printers, etc., corrugated board is used as an exterior packaging material while plastic foam primarily from expanded polystyrene (EPS) or polypropylene (EPP) is used as interior packaging/cushioning material. Packaging foam is evaluated for its ability to protect items from compression, shock, vibration, flexural stress, humidity and temperature extremes among other properties. Density and dimensional stability are also considerations. Both dynamic shock and compression tests have been used to evaluate foam packaging materials. EPS foam is one of the preferred internal packaging foams because of its lightweight, impact and moisture resistance, low cost, and ability to protect products from temperature extremes.

Despite its many advantages for internal packaging, EPS foam has become widely recognized for its negative impact on the environment. EPS is very resistant to biodegradation.

While there are claims that 19-25% of EPS foam is recycled, there are too few recycling centers available that process it. Furthermore, EPS recycling is expensive partly due to its bulk and resistance to compaction. These concerns have led several U.S. states and countries to enact legislation to ban some EPS foam products in efforts to phase-out its use. The development of alternatives to EPS and other plastic foam packaging is of broad interest.

Various foam products made from renewable materials have been developed. Composite foam products made from starch, fiber, and CaCO³ were produced from aqueous slurries using a baking process. Other starch and fiber foam composites have been made using solvent exchange, freeze-thawing or other processes. Extruded starch foam loose fill and cushioning panels have been commercialized and are used in a growing number of packaging applications.

Another process for making foam composites that has gained recent interest involves making a stable, wet foam from fiber/surfactant/polyvinyl alcohol (PVA) aqueous slurries and then drying in air or an oven. The wet foam slurry is sufficiently stable that it can be dried while maintaining a foam structure. As with EPS foam, cellulose fiber foam has excellent thermal properties. The wet fiber foam can be compression molded into distinct shapes or large panels needed for internal packaging. However, by themselves, fiber foams do not have the compressive strength (CS) or toughness (Ω) of plastic foams such as EPS foam. The CS and Ω of fiber foam could be increased by incorporating a binder such as starch and/or by embedding structurally reinforcing elements.

The need exists for an economical and biodegradable packaging material with CS and toughness that is equal to or better than EPS foam and other petroleum-based foam packaging materials. This disclosure is directed to a cellulosic fiber foam packaging material that preferably incorporates starch and/or embedded paperboard reinforcing elements to create a packaging material that is equivalent to (or better) than currently available petroleum-based packaging materials

### SUMMARY OF THE INVENTION

This disclosure is directed to a method of making a biodegradable high strength cellulosic fiber foam composite material. The method comprises providing cellulosic fibers, a foaming agent, and a polyvinyl alcohol fiber dispersant and binder. The cellulosic fibers are combined with the foaming agent, water, and polyvinyl alcohol to form a fiber foam wet mix. About 0-6.0 weight percent starch may also be added to the wet mixture.

The fiber foam mixture is poured into a mold and a paper-based reinforcing means is embedded in the fiber foam wet mix within the mold. The fiber foam wet mix with the embedded paper-based reinforcing means is oven dried so that the resulting high strength cellulosic fiber foam composite material that has a compressive strength of at least 72 kPa at 10% compressive strain, and a toughness of at least 0.34 Joules. The high strength fiber foam composite material has a greater compressive strength and toughness than the currently available nonbiodegradable expanded polystyrene packaging materials.

### BRIEF DESCRIPTION OF THE DRAWINGS

The patent or application file associated with this disclosure contains at least one drawing executed in color. Copies of this patent or patent application publication with color drawing(s) will be provided by the Office upon request and payment of the necessary fee.

FIG. 1 shows paperboard strips about 2.6 cm in width and 5 cm in length folded to form a ninety-degree angle. Nine of the folded strips weighing approximately 4.6 g in total were evenly spaced in a pattern shown in FIG. 1.

FIG. 2 shows six cylinders cut from paperboard tubes to a height of about 2.6 cm. Six of the cylinders weighing approximately 6.2 g in total were evenly spaced in a pattern shown in FIG. 2.

FIG. 3 shows a square grid made of 3.8 cm×3.8 cm elements. The grid was made by cutting sheets into strips 2.6 cm wide and cutting 1.4 cm slots every 3.8 cm using a bandsaw. The slotted strips were then assembled into a grid weighing approximately 22 g. The paperboard elements were embedded in the fiber foam as described infra.

FIG. 4 is an exploded view of the molding assembly 20 configured to mold the foam composites panels described herein.

FIG. 5A is a micrograph of the cross-section of the fiber foam with no starch (FF−S). Scale bar=0.5 cm.

FIG. 5B is a micrograph of the cross-section of the fiber foam with starch (FF+S). The FF+S sample is shown tilted slightly forward to show the smooth surface. Scale bar=0.5 cm.

FIGS. 6A-6F show photographs of fiber foam with starch (FF+S) and paperboard composite samples where the upper platen assembly was removed before the drying process. Specifically:

FIG. 6A shows an upper surface of a wet fiber foam panel (FF+S) before drying.

FIGS. 6B and 6C show a wet fiber foam panel (FF+S) after oven drying. FIG. 6B shows the smooth bottom surface of the fiber foam panel that is dried flat and in contact with the lower platen, while FIG. 6C shows an exposed fiber foam panel top surface that has dried unevenly.

FIGS. 6D-6F show examples of fiber foam top surface panel shrinkage/collapse which can occur and may be problematic. Note that the embedded paperboard elements minimize foam collapse, although localized shrinkage still left the top surface of the panels somewhat uneven.

FIGS. 7A-7D show photographs of fiber foam and paperboard composite samples where the platen assemblies were removed only after the drying process was completed. Specifically:

FIG. 7A shows a fiber foam panel with a smooth upper surface formed by completely filling the mold cavity and allowing the fiber foam panel to dry completely before removing the platen assemblies.

FIG. 7B shows a fiber foam panel with (right) angled paperboard elements wherein the platen assemblies were removed after the drying process was completed.

FIG. 7C shows a fiber foam panel with cylindrical paperboard elements wherein the platen assemblies were removed after the drying process was completed.

FIG. 7D shows a fiber foam panel with grid-type paperboard elements wherein the platen assemblies were removed after the drying process was completed.

FIG. 8 shows the mineralization of fiber foam samples as a function of time.

Mineralization of the samples with starch (FF+S) is shown as a dashed line, while mineralization of samples without starch (FF−S) is shown as a solid line.

FIG. 9A is a scanning electron micrograph (SEM) of the polystyrene beads in an EPS foam sample. Scale bars=1 mm.

FIG. 9B is a light micrograph of a fracture surface of an EPS foam sample that failed under flexural strain. Areas where adjacent beads were still attached (dashed arrows) and areas where beads had detached (solid arrows) can be seen. SEM micrographs clearly showed points of detachment where failure occurred. Scale bars=1 mm.

FIG. 10 shows stress-strain compression curves for EPS (solid line), fiber foam without starch (FF−S, dotted line) and fiber foam with starch (FF+S, dashed line).

FIG. 11 shows a stress strain curve for fiber foam alone without starch (FF−S), an FF composite panel with embedded (right) angled paperboard elements (FF−S Angle), an FF composite panel with embedded cylindrical elements (FF−S Cylinder), an FF composite panel with an embedded grid-type paperboard element (FF−S Grid). FIG. 11 also includes a stress curve (dashed line) for EPS foam.

FIG. 12 shows a stress strain curve for fiber foam alone with starch (FF+S), an FF composite panel with embedded (right) angled paperboard elements (FF+S Angel), an FF composite panel with embedded cylindrical elements (FF+S Cylinder), an FF composite panel with an embedded grid-type paperboard element (FF+S Grid). FIG. 11 also includes a stress curve (dashed line) for EPS foam.

FIG. 13 shows toughness ((Ω) of samples at 50% strain for five consecutive load/unload cycles. Samples include fiber foam (1), fiber foam with starch (2, upper line), angle composite (2, lower line), grid composite (3, bottom line), angle composite with starch (3, middle line), cylinder composite (3, top line), cylinder composite with starch (4), and grid composite with starch (5). Dashed line=EPS foam.

FIG. 14 shows normalized toughness for five consecutive load/unload cycles at 50% strain for fiber foam (1), fiber foam with starch (2), angle composite (3), angle composite with starch (4) and the cylinder and grid composites with or without starch (5). Dashed line=EPS foam.

Note that assemblies/systems in some of the FIGs. may contain multiple examples of essentially the same component. For simplicity and clarity, only a small number of the example components may be identified with a reference number. Unless otherwise specified, other non-referenced components with essentially the same structure as the exemplary component should be considered to be identified by the same reference number as the exemplary component.

### DETAILED DESCRIPTION OF PREFERRED EMBODIMENTS

The method and systems described herein comprise a fiber foam process that allows the embedment of reinforcing elements and binders (including starch) that can extend the range of compressive strength (CS) and toughness (Ω) beyond that of commercial plastic foams while maintaining low density and thermal conductivity—so that the fiber foam composite material comprises a “high strength” fiber foam composite.

For the purposes of this disclosure, a “high strength fiber foam material/composite” is

defined as a foam material having a compressive strength (CS) essentially equal to EPS with a density of 10-14.1 kg/m³ at 10% deformation as per standard methods as described in the appropriate American Society for Testing and Materials standard (ASTM D-1621). The 10% strain or deformation is the standard stipulated in ASTM D-1621. Using this criteria, high compressive strength is 72 kPa (see EPS below) or greater at 10% compressive strain. High strength is also defined as having a high toughness. High toughness ( Ω2c) is defined as having toughness values of 0.34 Joules or greater. Using this criteria, the fiber foam samples described herein having high Compressive Strength (CS) and high toughness. (See the values in the first two rows of Table 5 of this disclosure corresponding with EPS Foam, as well as FF−S Cyl., FF+S Cyl., FF−S Grid,, and, FF+S Grid.).

The biodegradable fiber foam compositions disclosed herein include fiber foam formulations with starch (FF+S), and fiber foam formulations without starch (FF−S). For the purposes of this disclosure, FF+S is defined as “cellulosic fiber foam with an effective amount of starch”. One of ordinary skill can determine the exact amount of starch that should be considered effective for a specific application. FF−S is defined as “cellulosic fiber foam with zero or a negligible (i.e. ineffective amount) of starch”. One of ordinary skill can determine the exact amount of starch that should be considered negligible for a specific application. FF+S and FF−S have many useful properties but lack the CS and Ω performance of expanded polystyrene (EPS) or polypropylene (EFF) plastic foams that are used extensively in internal packaging. The inventors found that adding starch to the fiber foam formulation increases the CS performance by 9.4 kPa compared to fiber foam without starch.

The inventors found that, surprisingly, adding paper-based reinforcing means or elements to biodegradable foam greatly increased the strength, toughness, and other performance characteristics of fiber foam composite materials much more than would normally be anticipated. For the purposes of this disclosure, “paper-based reinforcing elements or means” are defined as rigid and semirigid reinforcing elements that may be comprised of paperboard, cardboard, boxboard, kraftboard, and/or other wood and/or paper fiber-based biodegradable/recyclable materials.

Adding the angled paperboard elements did not significantly increase CS for FF−S but surprisingly did significantly increase CS for the FF+S sample. This surprising result demonstrates the synergistic effect of starch and the paperboard elements on CS.

The cylindrical and grid paperboard elements further significantly increase the CS for the FF+S sample so that the FF+S sample with the paperboard elements has a significantly higher CS than FF+S samples without them. The CS values for the FF+S angle and cylindrical samples were 33 and 69 kPa greater, respectively than the FF+S sample. The synergistic effect of starch on CS was also reflected in the FF+S grid composite which was 114 kPa greater than the FF−S grid composite. The inventors essentially found that composites made with reinforcing elements generally had superior performance relative to fiber foam without paperboard elements and that starch synergistically increased the CS of the composite foams. Furthermore, the composite foams compared favorably with commercial plastic EPS foam.

Specifically, cylindrical paperboard elements had the best overall performance in terms of flexural and compressive properties while still having low density and thermal conductivity. The paperboard composites had greater plastic behavior than EPS foam when subjected to high compressive strain (ϵc=50%). This resulted in lower toughness (Ω) than EPS foam when subjected to multiple load/unload cycles. The current disclosure clearly indicates that the fiber foam process described herein can provide a way to make composites with the broad range in mechanical strength needed for many applications, including economical fiber foam products that outperform currently available petroleum-based packaging materials.

### Materials and Methods

In the current example, pulped softwood fiber sheets were obtained from International Paper (Global Cellulose Fibers, Memphis, TN) produced at their Columbus, MS mill. The fiber was a Southern bleached softwood Kraft with a fiber length ranging from 3.8 to 4.4 mm. However, the fiber length may be in the range of 0.5 mm-5 mm. Although softwood fiber is used in the preferred embodiment, the scope of the invention may comprise all pulped plant fiber including hardwood, softwood; pulped fiber from crop residues such as wheat straw and other crop straws; recycled fiber from paper and paperboard, fibers and chopped fibers from fiber crops including sisal, cotton, jute, kenaf, and hemp, etc. The concentration of fiber on a wet basis (includes the water component) may range from 12% to 19% but more preferably from 14% to 17%, and most preferably from 15% to 16%.

The foaming agent preferably comprises sodium dodecyl sulfate. In alternative embodiments, the foaming agent may comprise any other foaming agent that produces a stable foam with the desired foam volume (Va). In the current example, the foaming agent comprises reagent grade sodium dodecyl sulfate (SDS, Cas 151-21-3) purchased from Thermo Fisher Scientific (Waltham, MA). In Table 2 of the current disclosure, the foam volume Va was 869% for FF−S and 601% for FF+S. The foaming agent may provide a Va from 200% to 1,200% and more preferably from 400% to 1,000% and most preferably from 600% to 900%.

Paperboard (brown kraft cardboard chipboard (22 point with a thickness of 0.56 mm) was purchased from Magicwater Via GSD (Fontana, CA). Brown kraft paperboard tubes (40 mm diameter×100 mm length×0.45 mm thickness) were purchased locally. Polyvinyl alcohol (PVA, Selvol 540, 88% hydrolyzed, 12% acetate, MW=120,000) was purchased from Sekisui Chemical (Pasadena, TX). Water soluble pregelatinized waxy corn starch powder (Clearjel) was obtained from Ingredion (Westchester, IL). Expanded polystyrene (EPS) foam sheets (122 cm×30.5 cm×2.62 cm) were purchased from a local craft store (Hobby Lobby, Grand Junction, CO).

Note that while the example described herein includes pregelatinized cornstarch, the starch may also be gelatinized in situ with heat. The starch may alternatively comprise starch derived from wheat, rice, peas, potato, etc, or any other starch source known in the art. Further, other binders should also be considered within the scope of the invention including but not limited to gelatin, agar, alginic acid, methyl cellulose, and synthetic polymers including polyvinyl alcohol, polyvinyl acetate and the like. The starch concentration (wet basis) may range from 0% to 6% but more preferably from 1% to 4% and most preferably from 2% to 3%.

An aqueous 5% (w/w) polyvinyl alcohol solution (PVA, Selvol 540, 88% hydrolyzed, 12% acetate, MW=120,000) was made by gradually adding PVA granules to cold water while continuously stirring and then slowly heating (95° C.) until the PVA was solubilized. Water was added to compensate for weight loss due to evaporation. A 29% (w/w) aqueous solution of Sodium Dodecyl sulfate (SDS) was made by combining the SDS powder and water at room temperature and continuously stirring to achieve dissolution.

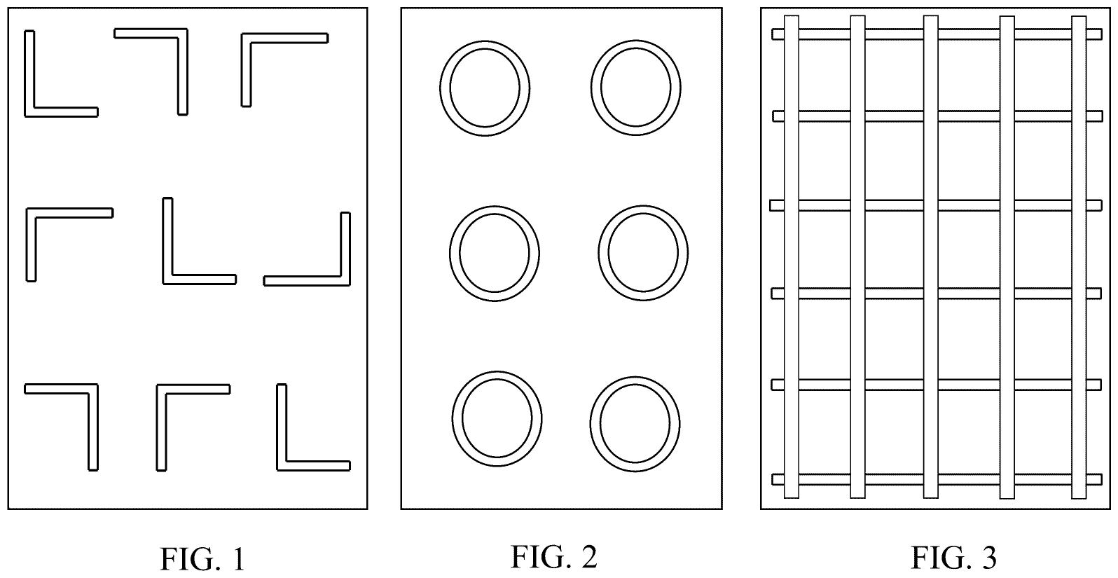

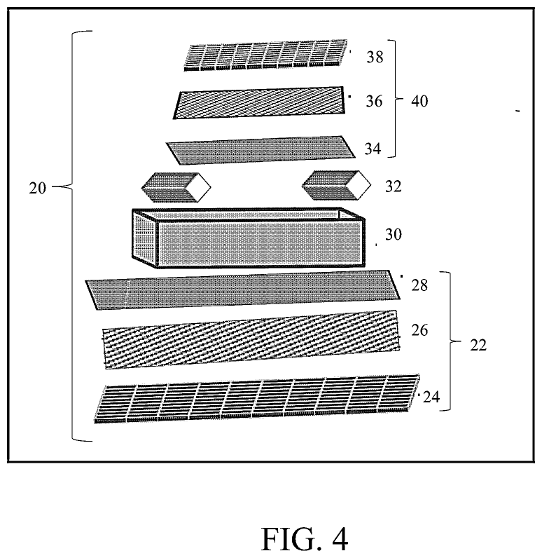

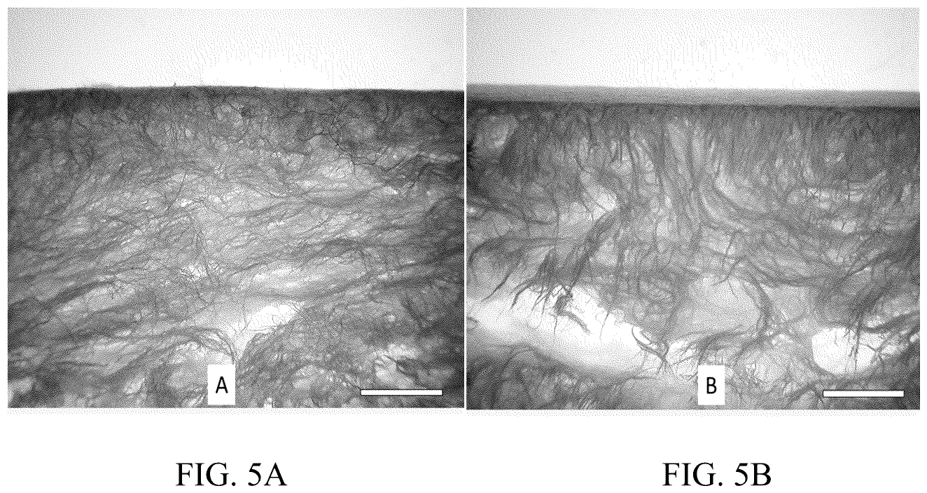

As shown in FIG. 1, paperboard support elements. Paperboard strips 26 mm in width and 52 mm in length were folded in half to form a 90-degree angle. Nine of the folded strips weighing approximately 4.6 g in total were used in a pattern of evenly spaced elements. FIG. 2 shows a second composite material comprising cylinders (40 mm dia.×26 mm height) cut from paperboard tubes. Six of the cylinders weighing approximately 6.2 g in total were embedded in the foam in an evenly spaced pattern. FIG. 3 shows a third composite insert comprising a paperboard grid containing square elements (38 mm length×38 mm width×26 mm height). The grid was made by cutting chipboard sheets into strips 26 mm in width and cutting 14 mm slots every 38 mm using a bandsaw. The slotted strips were then assembled into a grid weighing approximately 22 g. The paperboard elements were embedded in the fiber foam as described infra.

Although FIG. 3 shows a square grid, for the purposes of this disclosure, a “grid-type paper-based reinforcing means” is defined as a group of contiguous or connecting paper-based reinforcing means/elements arranged so that the elements/means form a network in a mold so that the cellulosic fiber foam wet mix can be poured adjacent to (and reinforced by) the paper-based reinforcing elements/means.

Although FIGS. 1 show the composite fiber foam materials molded into rectangular “panels” that may be used as packaging materials, in alternative embodiments the fiber foam composite materials may be molded into essentially any form known in the art consistent with the needs of a user and the characteristics of the embedded support elements/means. Although the panel form is preferred, the fiber foam composite materials may have a cubic, globular, pyramidal, or other geometric or nongeometric form-or essentially any form known in the art as limited by the functional needs of a user.

Similarly, although angular, cylindrical, and grid type elemental supporting means are disclosed, other geometrical and nongeometrical reinforcing means should be considered within the scope of the invention. Essentially, triangular, octagonal, or other matricies or combinations of geometric or nongeometric elemental means known in the art may be used in combination with the fiber foam material described. Although, in the preferred embodiment, the supporting elements are comprised of paperboard/cardboard, other materials may also be used consistent with producing a high strength, tough, resilient packaging material.

An aqueous 5% (w/w) PVA solution was made by gradually adding PVA powder to cold water while continuously stirring and then slowly heating (95° C.) until the PVA was solubilized. Water was added to compensate for weight loss due to evaporation. A 29% (w/w) aqueous solution of SDS was made by combining the SDS powder and water at room temperature and continuously stirring to achieve dissolution. The polyvinyl alcohol (PVA) acts as a fiber dispersant and binder. It allows the foam to be produced at reduced water concentrations. The PVA is dissolved in water and added to the fiber. The concentration of PVA on a dry basis may be from 4% to 12% but more preferably from 6% to 10% and most preferably from 7% to 9%.

The combined fiber and water sample was added to a 4 L mixing bowl of a planetary mixer (Model KSM 90, KitchenAid, Inc., St. Joseph, Michigan). For the control sample, the additional ingredients were added as shown in Table 1. The initial weight of the mixing bowl and ingredients was recorded. Water was added occasionally during the mixing step to compensate for weight loss due to evaporation. Mixing was started slowly (speed 3) and gradually increased to speed 10. A spatula was used to occasionally wipe down the bowl during mixing. Once a foam was produced, mixing was paused to measure the wet density (Dw) of the foam and to add water to compensate for any weight loss that occurred due to evaporation. Dw was determined by filling a cup to level and recording the weight and volume. Mixing was stopped once the desired Dw (Table 2) was achieved.

TABLE 1
Formulations of fiber foam (FF) samples with and without
starch (+S and −S, respectively, as well as wet and
dry mixes). Only the dry percentage (not the dry formulation
weight) of each ingredient is included in the parentheses.

| Sample | FF (−S) Wet | FF (+S) Wet | FF (−S) Dry | FF (+S) Dry |
|---|---|---|---|---|
| Fiber | 50 g | 50 g | (89%) | (77.6%) |
| | (19.7%) | (15.9%) | | |
| Water | 100 g | 150 g | (0%) | (0%), |
| | (39.4%) | (47.6%) | | |
| PVA | 100 g | 100 g | (8.9%) | (7.8%) |
| (5% soln) | (39.4%) | (31.7%) | | |
| SDS | 4 g | 8 g | (2.1%) | (3.7%) |
| (29% soln) | (1.57%) | (2.54%) | | |
| Starch | 0 g | 7 g | (0%) | (10.9%) |
| | | (2.22%) | | |

The mixing procedure for the fiber foam with starch (FF+S) sample was similar to FF−S except that the water-soluble starch powder was gradually added to the mixing bowl only after the ingredients had started to foam. The starch powder was slowly added to the foam while mixing to ensure that the starch properly dispersed and solubilized in the foam mixture. Starch tended to reduce the foam volume which necessitated higher amounts of water and foaming agent compared to the control (Table 1). Notwithstanding the additional amount of water and foaming agent, the final Dw of the foam containing starch was higher than foam without starch (Table 2).

The total water content of the foam may be in the range of 65% to 95% but more preferably 75% to 85% and most preferable from 77% to 80%.

The air uptake volume (Va) of the foam was calculated using Eq. 1 where Vsystem is the volume of the ingredients before foaming and Vₐᵢᵣ is the bulk volume of the foamed material. The V_{system} was derived from the specific gravity of each component. Specific gravity values were obtained using a helium gas displacement pycnometer (Micromeritics, model AcuPyc II 1340, Norcross, GA). The specific gravity values (g/cm³) of the dry ingredients used in calculations included the following: fiber (1.61); PVA (1.30); SDS (1.01); starch (1.46). The specific gravity of water (1.0 g/cm³) was used to determine the volume of water added including in the SDS and PVA solutions. The V_{system} values (cm³) for the control and starch formulations as shown in Table 1 were 234 cm³ and 288 cm³, respectively. The Vair values for the control and starch formulations were 2,032 cm³ and 1,731 cm³, respectively.

$$Va ( \% ) = {V}_{air} / {V}_{system} \times 100 \qquad Eq . 1$$

The inventors disclose and discuss the composition of various preferred foam compositions in co-pending U.S. patent application Ser. Nod. 16/832,650 (USDA Dkt. 62.18), 17/876,040 (Dkt. 31.22), and 18/090,713 (Dkt. 48.21)—all of which are all hereby incorporated by reference.

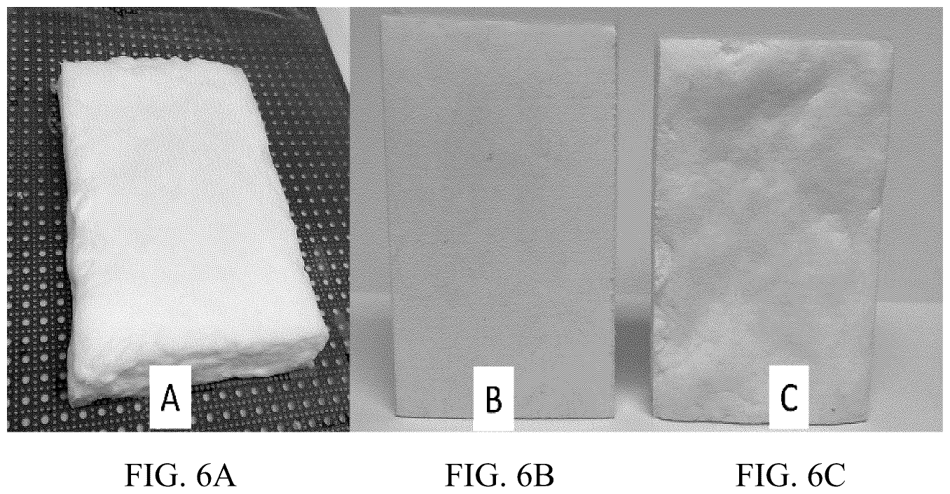

As shown in FIG. 4, the mold assembly 20 generally comprised of upper 40 and lower 22 porous platen assemblies. The lower platen 22 consisted of a rigid plastic grate 24, a perforated metal sheet 26, and a sheet of silk screen 28. A wooden frame 30 rested on top of the lower platen 22. Four wooden blocks 32 (for simplicity, only two are shown in FIG. 4) were placed inside the mold against the inner sides of the wooden frame 30. The blocks 32 served as stops for the upper platen 40 and created a mold cavity for the foam. The foam and paperboard elements were placed inside the mold cavity. The upper platen 40 consisted of a sheet of silk screen 34, a perforated metal sheet 36 and a rigid plastic grate 38. The upper platen 40 was mobile and fit inside the wooden frame 30. Excess foam was loaded in the mold cavity such that the upper platen 40 could compress the foam making it conform to the shape of the mold cavity. The lower platen 22 was fixed at the bottom of the mold assembly 2 and was immobile while the upper platen 40 fit inside a wooden frame 30 and was mobile.

The lower platen rigid grate 24, and upper platen rigid grate 38 was comprised of a rigid plastic. The lower platen metal sheet 36 and upper platen metal sheet 26 was comprised of a rigid sheet of aluminum (0.50 mm, Lincane, Randall Manufacturing Co., Inc., Newark NJ). The lower platen silk screen 28, and upper platen silk screen 34 was comprised a sheet of monofilament polyester silk screen (110 mesh).

A wooden frame 30 (26 cm×26 cm×10 cm, inside dimensions) was positioned on top of the lower immobile platen 22 (30 cm×30 cm). In contrast, the upper platen 40 (25.25 cm×25.25 cm) was mobile and able to fit inside the wooden frame 30. Four wooden blocks 32 consisting of two long (24.5 cm×2.54 cm×2.54 cm) and two short (20 cm×2.54 cm×2.54cm) blocks were assembled against the inside of the wooden frame 30, all of which rested atop the lower platen.

The blocks 32 served as stops for the upper platen 40 and the square space inside the blocks 32 formed the mold cavity. The volume of the mold cavity was calculated from dimensional measurements. The weight of foam required to overfill the mold cavity to 135% of the mold cavity volume was calculated from the Dw values. After loading the mold cavity with excess foam, the upper platen assembly 40 was lowered inside the wooden frame 30 and manually compressed until the wood blocks 32 were reached and prevented further movement.

For the incorporation of the fiber foam/paperboard composites (See FIGS. 1-3), approximately 80% of the foam was added to the mold cavity. A spatula was used to spread the foam uniformly inside the mold cavity. The paperboard elements were then carefully pressed into the foam in the prescribed patterns, best shown in FIGS. 1-3. The remaining quantity of foam was spread on top of the paperboard elements and the upper platen assembly 40 was manually compressed inside the wood frame 30 until contacting the wooden blocks 32.

Following the compression molding step, the wood frame 30 was carefully lifted and removed while holding the platen assemblies 32, 40 in place. The grates 24, 38 were removed from the upper and lower platen assembly. The upper platen assembly 40 and wood blocks 32 were removed so that the foam sample was left resting on the lower platen assembly 22 with the sides and top surface exposed. This was done to determine whether drying time could effectively be minimized. However, this method of drying left the sample vulnerable to some shrinkage and distortion. Therefore, a second set of foam samples was also prepared where the upper platen assembly 40 and wood blocks 32 were not removed. The intact assembly 20 was placed in the drying oven and a weighted rack was placed on top of the assembly to ensure the upper platen 40 did not rise due to thermal expansion of the foam during the drying process.

The foam samples were oven-dried at 80° C. The weight loss was monitored by periodically weighing the samples. The end time for drying was recorded as the point where less than 0.15% of the initial weight of the foam was lost over a 30 min drying interval. The initial and end times for drying were taken to record the total drying time.

Compressive and flexural properties of the samples were measured using a universal testing machine (Model ESM303, Mark-10, Copiague, NY). The compressive properties of dry foams were measured on samples cut to dimensions approximately (5 cm×5 cm) as per ASTM standards (D-1621) using a band saw. Final dimensions were measured using calipers. The samples were conditioned for 48 hours in a chamber with a small circulating fan. The relative humidity of the chamber was maintained near 50% using a saturated salt solution (Mg(NO₃)·6H₂O) as previously described. Compression tests were performed using a deformation rate of 12.5 mm/min as per established methods (ASTM D 1621). Compressive strength (CS) was recorded as the stress at the yield point before 10% strain. The fiber foam without starch did not have a clear yield point so the stress at 10% strain was recorded as the CS as per ASTM standards. Samples were subjected to five load/unload cycles up to 50% strain using a deformation rate of 2.5 mm/min. The area under the loading curve was used to calculate toughness (52). A minimum of five replicates were made for each treatment.

Three-point flexural tests were performed using samples cut to dimensions approximately (20 cm×5.0 cm×2.6 cm). The final width and thickness measurements of samples were recorded using calipers. The flexural tests were performed using a deformation rate of 2.5 mm/min and a span distance of 152 mm and a span: depth ratio of 5.85. Flexural stress (of) and strain (ϵf) were calculated as per ASTM D790.

The dry bulk densities of the samples were determined from volume and weight measurements of oven-dried specimens. Helium gas displacement pycnometry was used to determine the specific density (dn) of the foam solids. Porosity (P) was determined from the bulk density of the foams (da) and the specific density of the foam (dn) using Eq. 2, which was obtained from the simple mixing rule with a negligible gas density. The dn value of the foam solids from gas pyncnometry was 1.55 g/cm³.

$$P ( \% ) = 100 \times ( 1 - da / dn ) \qquad Eq . 2$$

Thermal conductivity was measured at a mean temperature of 22.7° C. on panel samples for each treatment according to standard methods (ASTM C-177-85) using a thermal conductivity instrument (model GP-500, Sparrell Engineering, Damarascotta, ME). Readings were taken at 1 hour intervals as the instrument approached thermal equilibrium.

Light micrographs were taken using a digital microscope (Dino-Lite model AM3113,Torrance, CA) equipped with image capture software (Dinocapture 2.0). Cross-sectional slices (1 cm) of fiber foam samples with and without starch were cut using a scroll saw. Back lighting was used to provide higher contrast micrographs. Micrographs of the cross-sectional surface of EPS foam that had failed under flexural stress were taken by both light and scanning electron microscopy (SEM). For SEM micrographs, samples were examined in a JEOL JSM-7900 F field emission scanning electron microscope (SEM) at 2 kV and imaged at 2560×1960 ppi using a JEOL camera and software (JEOL, Japan). The EPS foam samples were adhered to aluminum specimen stubs using double-sided adhesive-coated carbon tabs (Ted Pella, Inc., Redding, CA). The samples were then sputter-coated with platinum in a Leica EM ACE 600 sputter coating unit (Leica Microsystems, Wetzlar, Germany).

An automated respirometer system (Microoxymax, Columbus Instruments, Columbus, OH) was used to monitor the mineralization of the fiber foams as per ASTM methods (D5338) with only minor modification. Compost purchased locally was sieved (14 mesh) and stored overnight for moisture equilibration. Moisture content was determined gravimetrically by drying 10 g samples at 105° C. for 16 hours.

Fiber foam samples (with and without starch) were cut into small pieces (<5 mm), and weighed (˜0.5 g) to the nearest 0.1 mg. The samples were added to a reaction jar along with compost (24.5 g) taking care to ensure uniform mixing. The moisture content was adjusted to 58% by adding water before beginning a run. Samples were kept for two days at 30° C. before raising the temperature to 58° C. During the run, the CO₂ concentration was measured at 2 hour intervals. Water (2 mL) was added daily to maintain the moisture content range between 50 and 60%. The carbon content of the samples was determined using a CHN Analyzer (Perkin Elmer 2400 Series II, Boston, MA). The theoretical percent biodegradation was calculated as the ratio of the moles of carbon in the sample versus the accumulated moles of CO₂ produced utilizing the ideal gas law as previously described.

The data were analyzed by a one-way analysis of variance. A Tukey-Kramer Post Hoc test (α<0.05) was used to determine differences between treatment means.

### Results and Discussion

The foam ingredients, SDS and PVA which were included in all the formulations were important in foaming and dispersing the fiber in the relatively low moisture levels used (Table 1). Starch and PVA are binders and sizing agents that coat fibers and tend to increase stiffness and rigidity. The addition of starch as a binder decreased the foaming volume (Va) (Table 2). Adding higher amounts of water and foaming agent to the starch-containing mixture helped boost the Va. Still, the Va was higher in the fiber foam without starch (FF−S) and resulted in a lower wet density (Dw) compared to the fiber foam containing starch (FF+S, Table 2).

TABLE 2
Wet density (Dw), foam volume (Va), drying time (Td), thickness (T), dry density (Dd),
porosity (P), and thermal conductivity (TC) of wet and dry fiber foam with and without
starch (FF + S and FF − S, respectively) and composites containing paperboard
elements (angle, cylinder, grid) prepared using a planetary mixer. EPS = expanded polystyrene.

| | | | FF − S | FF + S | FF − S | FF + S | FF − S | FF + S | EPS |
|---|---|---|---|---|---|---|---|---|---|
| Sample | FF − S | FF + S | Angle | Angle | Cyl. | Cyl. | Grid | Grid | Foam |
| Dw | 125a* | 182b | N/A | N/A | N/A | N/A | N/A | N/A | N/A |
| (kg/m³) | | | | | | | | | |
| Va | 869a | 601b | N/A | N/A | N/A | N/A | N/A | N/A | N/A |
| (%) | | | | | | | | | |
| Td | 345a | 510c | 343a | 517c | 379ab | 495c | 405b | 555c | N/A |
| (min)** | | | | | | | | | |
| Td | 336a | 528c | 333a | 510c | 311a | 529c | 399b | 553c | N/A |
| (min)*** | | | | | | | | | |
| T** | 2.52b | 2.40a | 2.71bc | 2.74c | 2.77c | 2.76c | 2.99d | 3.02d | 2.61b |
| (cm) | | | | | | | | | |
| T*** | 2.66a | 2.62a | 2.63a | 2.63a | 2.62a | 2.61a | 2.70a | 2.65a | 2.61a |
| (cm) | | | | | | | | | |
| Dd*** | 33.1b | 39.1c | 35.9bc | 44.9d | 39.1c | 44.9d | 57.1e | 64.9f | 14.1a |
| (kg/m³) | | | | | | | | | |
| P | 97.9a | 97.5a | N/A | N/A | N/A | N/A | N/A | N/A | 98.6b |
| (%)*** | | | | | | | | | |
| TC*** | 0.039ab | 0.043abc | 0.042ab | 0.044bcd | 0.042ab | 0.044bcd | 0.048cd | 0.049d | 0.038a |
| (W/mK) | | | | | | | | | |

*Statistical mean values within the rows of this table that are followed by a different letter (a, b, c, d, etc.) are significantly different (p < 0.05).
**Samples dried with upper platen assembly removed to expose maximum surface area.
***Samples dried inside the platen assemblies.

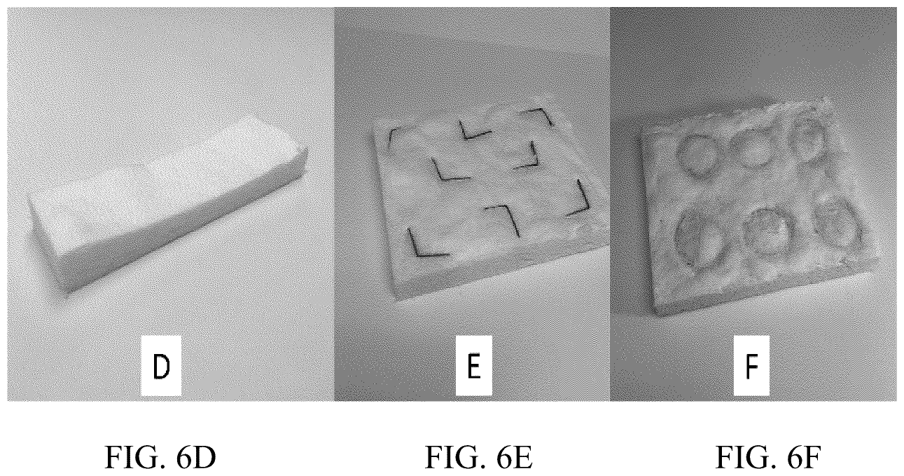

The foaming process produced a stable wet foam that could easily be compression molded into panels. As shown in FIGS. 5A and 5B (and as discussed supra), compression molding collapses the foam at the surface and creates a smooth skin. The interior of the dry foam consisted of a porous network of dispersed fibers. In the dry foam, there were void spaces that were interspersed throughout the interior. The voids were more prevalent in the FF+S (FIG. 5B).

One of the limitations of the fiber foam process is the time required to fully dry the foam. Efforts were made to minimize the drying time of compression molded foam panels by maximizing the exposed surface area. This was done by removing the wood blocks 32 and upper platen assembly 40 (as best shown in FIG. 4) leaving the exposed wet sample resting solely on the lower platen assembly 22 with the top surface and sides exposed. The drying time was compared with that of samples left inside the intact, porous platen assemblies 22, 40 as previously described supra in the Materials and Methods section.

Surprisingly, there was no significant change in drying time (paired t-test, t=0.567). This result could be partly attributable to the data variability which makes it more difficult to detect small statistical differences. The more likely explanation is that the vapor diffusion rate inside the foam matrix itself was rate limiting rather than the porous platen assemblies 22, 40. The influence of the foam matrix in determining the drying rate was further demonstrated by the effect of adding starch (Table 2). The FF+S sample took on average 151 additional minutes to dry compared to the FF−S sample which was statistically significant (paired t-test, t=6.44×10⁻⁴).

The drying process is rather complex and is affected by the presence of starch and/or PVA which are both dissolved in the liquid phase. Drying involves vaporization of both free and bound water. Initially, as the foam temperature rises, the vapor pressure also increases. The vapor transmission rate was too slow to fully dissipate the vapor pressure generated inside the foam matrix, especially in the FF+S sample. As a result, the foam swelled which could account for the formation of void spaces interspersed in the foam interior-as shown in FIGS. 5A and 5B.

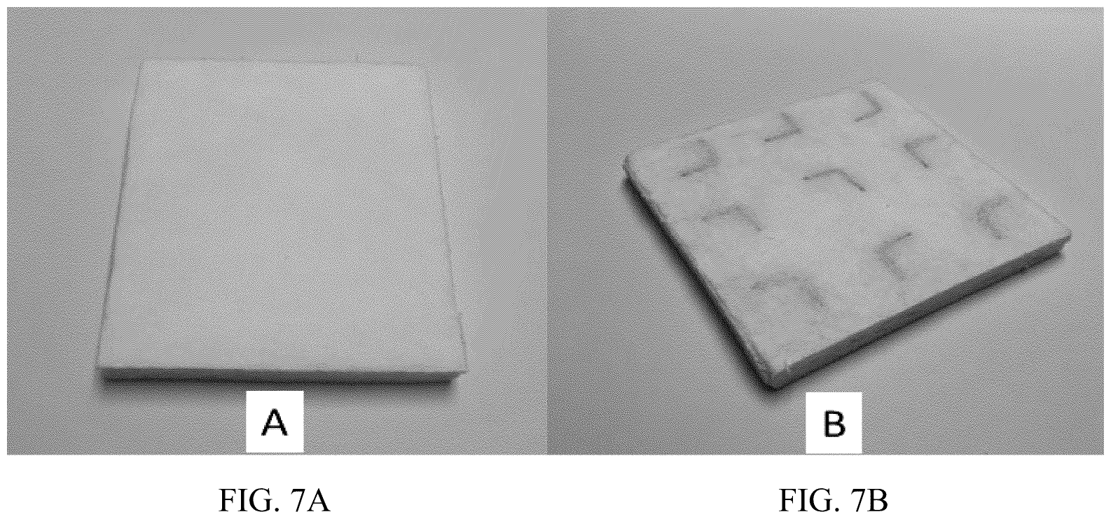

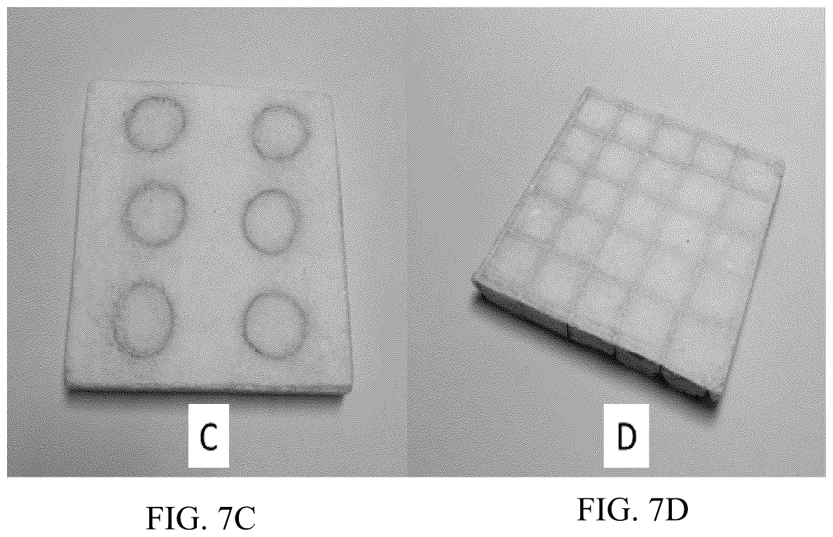

Once the wet foam is placed in the drying oven, the amount of free water steadily decreases due to vaporization. At the same time, both the volume of water vapor generated, and the internal pressure which had driven the initial swelling of the foam slowly decreased. This resulted in some shrinkage or collapse depending on whether the sample was exposed (FIG. 6) or dried inside the platen/mold assemblies (FIG. 7).

Wet fiber foam with maximum surface area exposed (FIG. 6A) was not dimensionally stable during oven-drying. Only the bottom surface of the foam was in contact with lower platen assembly during the drying process. The bottom surface of the dried foam (FIG. 6B) remained flat while top surface was uneven (FIG. 6C). FF+S samples could experience excessive shrinkage, especially in the central region of panels (FIG. 6D). Surpringly, paperboard elements in composite samples prevented excessive shrinkage although there were localized areas of shrinkage on the upper surface of the foam (FIG. 6E-6F). Localized shrinkage made the upper surface uneven and the panel thickness more variable (FIG. 6D-6F, Table 2). Nevertheless, it was unexpected that the paperboard elements would control shrinkage of the foam and produce a more uniform foam thickness.

In contrast, foam samples dried inside the platen assemblies surprisingly had smooth finishes on both the top and bottom surfaces and dried at a similar rate as samples removed from the platen assemblies before oven drying (FIG. 7A-7F). This was due to the platen assemblies restricting the swelling during the drying process. Some lateral expansion, however, did occur since lateral expansion was not restricted by the platen assemblies. Both PVA and starch can bind the fiber foam surfaces to the platens during drying. As a result, the shrinkage or collapse as seen in the foam samples removed from the upper platen before drying (FIG. 6D-6F) did not occur and sample thickness was much more consistent (Table 2). Despite the foam surfaces adhering to the platen assemblies, the platen was able to be removed at the end of the drying process. Because of their improved aesthetics and dimensional stability, foam panels were prepared and oven-dried with the platen assemblies intact for the remaining experiments on mineralization and characterization of mechanical properties.

The fiber in the dried fiber foam materials with starch (FF+S) has a functional range of 65-90%, a more preferred range of 75-82%, and a most preferred range of 77-79%. The dried FF+S polyvinyl alcohol has a functional range of 6.5-9.5% a more preferred range of 7.3-8.5%, and a most preferred range of 7.7-8.0%. The dried sodium dodecyl sulfate has a functional range of 2-6% a more preferred range of 3-4.5%, and a most preferred range of 3.5-4.0%. The dried starch has a functional range of 5-25% a more preferred range of 8-15%, and a most preferred range of 10-12%.

As previously mentioned, the fiber foam and composite foams containing starch required significantly longer drying times (Td, Table 2), which was probably due to a decreased vapor transmission rate inside the foam itself. Starch increased the Dw of wet foam and significantly (paired t-test, t=0.00258) increased the dry density (Dd) of fiber foam and paperboard foam composites (Table 2).

The foam samples had lower porosity (P) and much higher Dd than EPS foam (Table 2). Still, the foam samples and paperboard composites had low density and surpringly excellent thermal insulative properties. The thermal conductivity (TC) of FF−S was similar to that of EPS foam (Table 2). Adding the angle and cylindrical paperboard elements to the foam slightly increased the Dd and TC (Table 2). The grid paperboard element was much heavier (22 g) than the collective weight of the angle (4.62) and cylindrical (6.22) elements. As a result, the grid composites had higher Dd and TC compared to the angle and cylinder composites (Table 2).

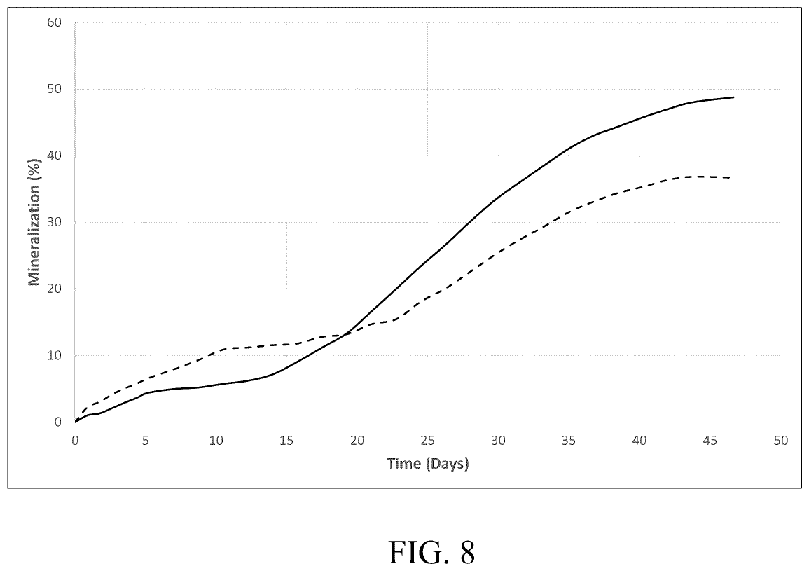

The mineralization of fiber foams both with and without starch was observed over a 46 day period (FIG. 8). Mineralization was initially higher in samples containing starch (FIG. 8, dashed line). This was likely due to the readily biodegradable nature of the starch component. The results show significant mineralization occurred in both foam samples (FF−S, FF+S).

The effect of paperboard reinforcing elements on the mechanical properties of the fiber foam was characterized for both flexural and compressive strain. The paperboard grid element had an interlocking structure that provided the greatest flexural strength (σfM) observed from all the composites samples tested (Table 3).

In contrast to the grid element, the angle and cylinder elements that were embedded into the foam were not interconnected in any way other than through the foam matrix itself. It was not surprising then that the σfM values for the FF−S angle and cylinder composites were not significantly greater than for the FF−S sample even though their mean values trended higher (Table 3).

Surprisingly, this was not the case for the FF+S samples where the σfM values for angle and cylinder composites were significantly greater than for the FF+S sample. This result is likely due to the ability of starch to bind the fibers and the paperboard elements together and form a rigid matrix. Foam samples containing starch had greater flexural strength than the corresponding samples without starch and were similar to or greater than the σfM values for EPS foam (Table 3).

TABLE 3
Flexural strength (σ_{fM}), strain (ε_{fM}), and modulus (Ε_{f}) of fiber
foam (FF) with and without starch (+S and −S, respectively), fiber
foam composites containing paperboard elements (angle, cylinder, grid), and EPS foam.

| | | | FF − S | FF + S | FF − S | FF + S | FF − S | FF + S | EPS** |
|---|---|---|---|---|---|---|---|---|---|
| Sample | FF − S | FF + S | Angle | Angle | Cyl. | Cyl. | Grid | Grid | Foam |
| σ_{fM} | 30.8a* | 94bc | 36a | 173d | 67ab | 224e | 191de | 460f | 143cd |
| (kPa) | | | | | | | | | |
| ε_{fM} | 3.56ab | 3.57ab | 5.52bc | 4.18ab | 4.48ab | 4.40ab | 2.90a | 3.29a | 7.10c |
| (%) | | | | | | | | | |
| Ε_{f} | 1.12a | 4.32ab | 1.21a | 9.45bc | 2.57a | 11.9c | 10.6c | 22.9d | 4.29a |
| (MPa) | | | | | | | | | |

*Statistical mean values (n = 5) within the rows of this table that are followed by a different letter (a, b, c, d, etc.) are significantly different (p < 0.05).

The flexural modulus (Ef) data showed trends similar to that for σfM (Table 3). The highest Ef values were obtained for the paperboard grid composites. Foam samples containing starch had greater Ef than the corresponding samples without starch. The FF+S sample had Ef values similar to EPS foam. However, the Ef values for all the FF+S paperboard composites were greater than the values for EPS foam. These results underscore the role of starch in providing greater rigidity to the FF samples.

The skin that was present on the top and bottom surfaces of the foam samples likely contributed to the flexural strength and modulus. There was a large amount of variability in the flexural data, which was likely due to the positioning of the paperboard elements within the samples. The fiber foam and composite foams tended to yield and bend rather than break under flexural stress.

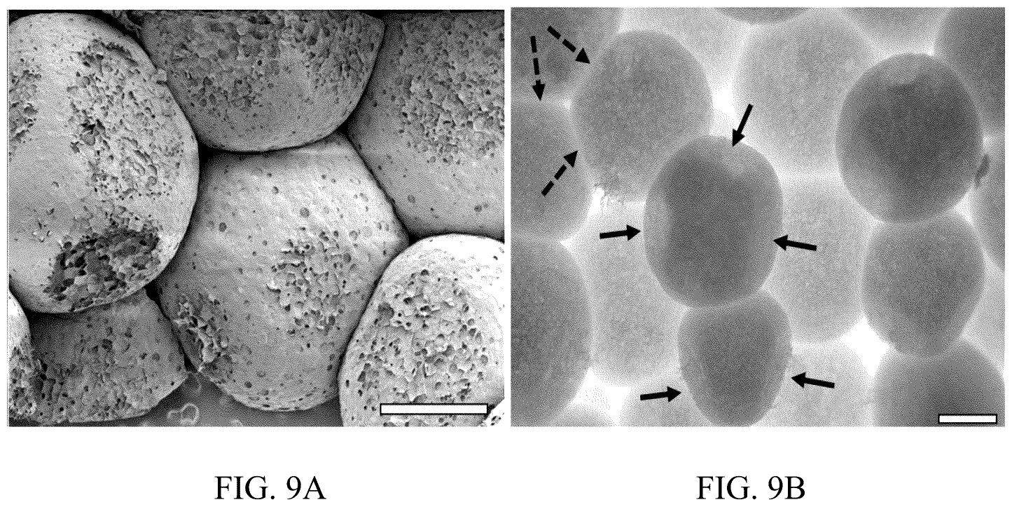

In contrast, the EPS foam flexed but eventually broke at a relatively high amount of flexural strain (Table 3). Failure analysis showed that fracture occurred at the point of bead-bead attachment. FIG. 9A shows an electron scanning microscope photograph wherein examples of bead-bead attachment are apparent. Remnants of debris from failure at the bead-bead attachment were seen in light and SEM micrographs (FIG. 9B). In three-point bending tests, there are compressive forces generated at the upper surface and tensile forces at the bottom surface of the sample as bending occurs. The failure in EPS foam initiated at the bottom of the sample and below the loading anvil where tensile stresses were greatest. The break propagated upward towards the nose of the anvil.

One of the concerns with EPS foam is that its lightweight and water repellency allow it to quickly disperse in the environment by wind and water through floating along waterways. Dispersion is further enhanced when the EPS foam is broken apart or reduced to individual beads when subjected to mechanical stresses. EPS foam may become brittle from exposure to ultra violet radiation and further reduced to microplastic that can enter the food chain. With no meaningful biodegradation, microplastics can persist in the environment for decades or centuries.

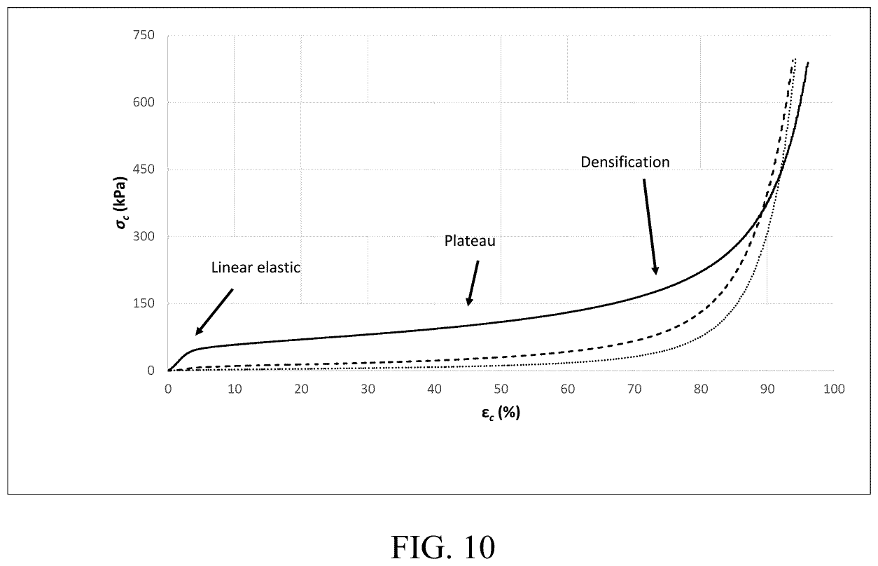

Compression stress/strain curves for EPS and fiber foam samples with and without starch were typical of elastomeric foam samples (FIG. 10). As with EPS foam, the fiber foam samples compressed and densified under increasing strain (ϵc). There was a linear elastic region at the beginning of the curves followed by a plateau region where the stress (σc) increased at a relatively slow rate compared to the change in ϵc. For closed cell foams like EPS foam, the cell walls begin to bend and collapse in the plateau region due to elastic buckling and plastic yielding.

For fiber-based foams, the network of fibers comprising the matrix developed a level of stiffness and rigidity during the drying process and resisted compression. The fiber foams were similar to cellular foams in the sense that both an elastic and plastic behavior occurs in the plateau region. Elastic bending and buckling of individual fibers likely occurred followed by plastic yielding as the fibers begin to collapse onto one another during compression tests. The addition of starch increased the compressive strength (CS) and toughness (Ω, area under the stress-strain curve) compared to the FF−S sample (FIG. 10).

In compression tests, the FF−S sample had far lower CS and elastic modulus (Ec) compared to the EPS foam (FIG. 10 and Table 4). The angle paperboard composites had CS and Ec values in the range of EPS foam. Meanwhile, the cylinder and paperboard composites had significantly higher CS and Ec than EPS foam whether they contained starch or not (Table 4). However, fiber foam and composites containing starch had higher mean values than the corresponding samples without starch. These differences were significant for the paperboard cylinder and grid composites (Table 4).

TABLE 4
Compressive strength (CS) strain (ε_{c}), and modulus (E_{c}) of fiber
foam (FF) with and without starch (+S and −S, respectively) and
fiber foam composites containing paperboard elements (angle, cylinder, grid).

| | | | FF − S | FF + S | FF − S | FF + S | FF − S | FF + S | EPS |
|---|---|---|---|---|---|---|---|---|---|
| Sample | FF − S | FF + S | Angle | Angle | Cyl. | Cyl. | Grid | Grid | Foam |
| CS | 1.6a* | 10ab | 30abc | 63c | 121d | 187e | 192e | 305f | 55bc |
| (kPa) | | | | | | | | | |
| ε_{c} | 10e | 9.22e | 6.0cd | 2.1a | 6.8d | 3.9abc | 4.5bc | 3.7ab | 4.0cde |
| (%) | | | | | | | | | |
| E_{c} | 0.016a | 0.16a | 0.70a | 3.4bc | 2.1ab | 5.0bc | 5.1bc | 8.7d | 1.7ab |
| (MPa) | | | | | | | | | |

*Statistical mean values (n = 5) within the rows of this table that are followed by a different letter (a, b, c, d, etc.) are significantly different (p < 0.05).

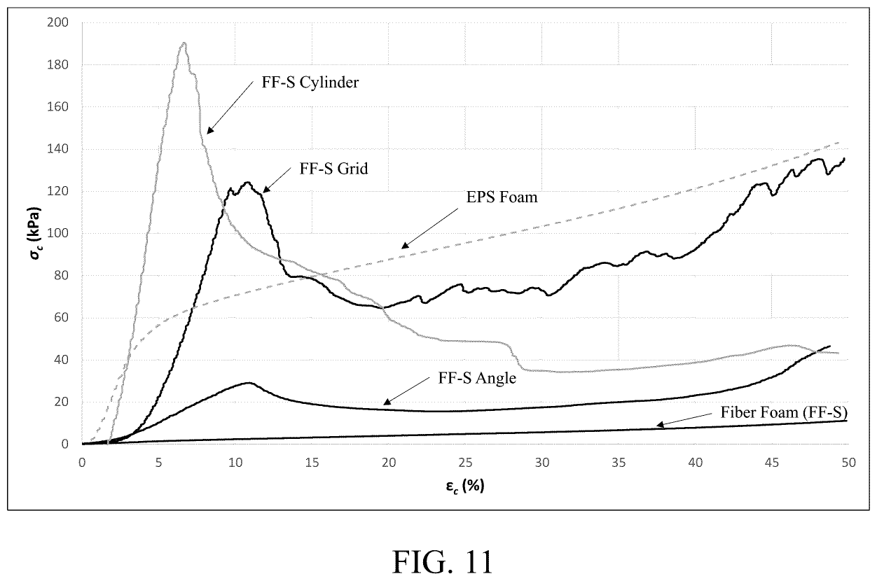

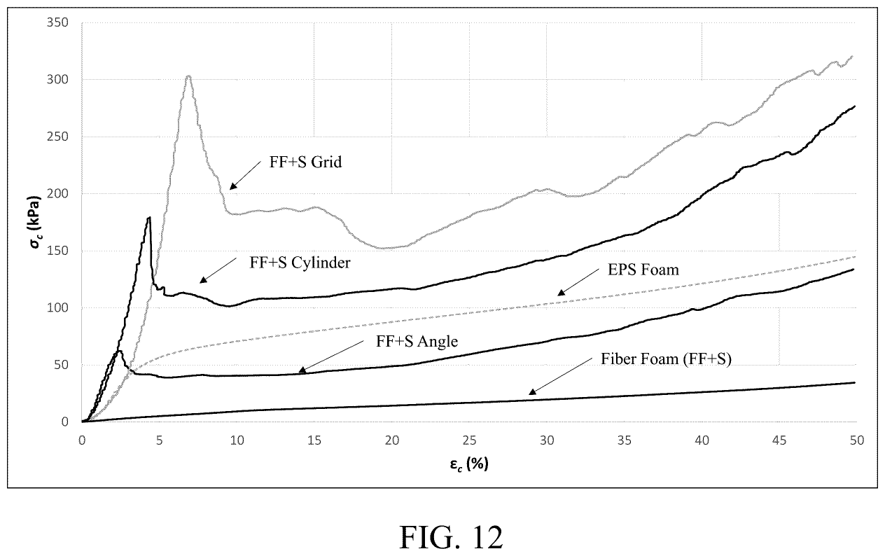

EPS foam is reported to resist shock and deformation up to 50-60% strain. Typical compression stress-strain curves up to ϵ=50% for FF−S, FF+S, and their paperboard composites were compared to EPS foam (FIGS. 11 and 12, respectively). An initial maximum peak in σc was reached in the composites for ϵc=3.8% to 6.8% followed by a decrease and eventual rise again in σc values (except for the grid sample) in the range of ϵc=25% to 50% (FIGS. 11 and 12, and Table 4).

Visual observation of the paperboard elements under compressive stress revealed that the elements gradually crushed and compressed under load except for the grid composite without starch (FIG. 11). In this sample, the lack of foam rigidity allowed movement within the grid elements and eventual collapse under load from a combination of tearing and bending. The slots that were cut to make and assemble the grid structure tended to provide sites of tear propagation that ultimately weakened the overall structure. In contrast to the paperboard grid, the cylinder paperboard elements slowly crushed but did not tear. As a result, the cylinder composite exhibited greater strength at higher levels of ϵc and near the range for EPS foam (FIG. 11). Of the FF−S composite samples tested, the composite containing cylindrical elements provided the best combination of strength and low density (FIG. 11, Table 2).

Surprisingly, the FF+S paperboard composites generally exhibited a much higher range in σc values than the corresponding FF−S composites (compare FIGS. 11 and 12). Additionally, after the initial peak and decrease in values, the σc remained higher in the FF+S cylinder and grid paperboard composites than for EPS foam (FIG. 10). The FF+S angle composite had lower σc values than the EPS foam but still near the range (FIG. 10, Table 5).

The compressive stress and toughness (σc, Ωc, respectively) of FF−S, FF+S, and paperboard composites were determined at three different levels of strain (ϵc=10%, 25%, and 50%). The FF−S, FF+S, and FF−S angle composite had σc and Ωc values significantly lower than the EPS foam sample at all three levels of ϵc. The paperboard grid and cylinder composites had σc and Ωc values similar to or exceeding the values for EPS foam while the FF+S angle composite had intermediate values (Table 5).

TABLE 5
Compressive stress (σ_{c}), and toughness (Ω_{c}) at 10% strain for fiber foam with
and without starch (FF + S and FF − S, respectively), fiber foam composites
containing paperboard elements (angle, cylinder, grid), and expanded polystyrene (EPS) foam.

| | | | FF − S | FF + S | FF − S | FF + S | FF − S | FF + S | EPS |
|---|---|---|---|---|---|---|---|---|---|
| Sample | FF − S | FF + S | Angle | Angle | Cyl. | Cyl. | Grid | Grid | Foam |
| σ_{c} (kPa) | 1.6a* | 11a | 21ab | 44b | 80c | 115d | 92c | 206e | 72c |
| ε_{c} = 10% | | | | | | | | | |
| Ω_{c} (J) | 0.0056a | 0.041a | 0.13ab | 0.24b | 0.46c | 0.74d | 0.77d | 1.1e | 0.34c |
| ε_{c} = 10% | | | | | | | | | |

*Statistical mean values (n = 5) within the rows of this table that are followed by a different letter (a, b, c, d, etc.) are significantly different (p < 0.05).

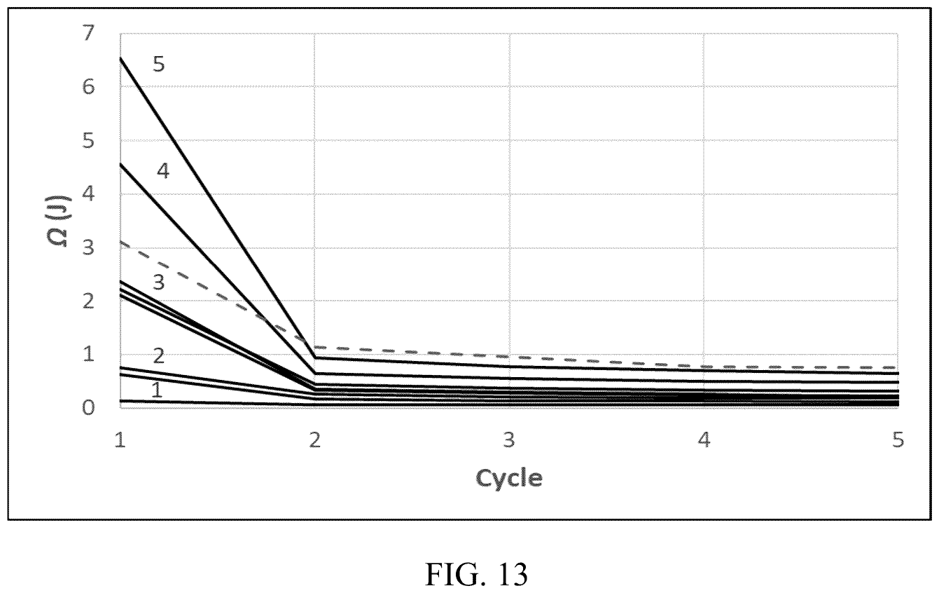

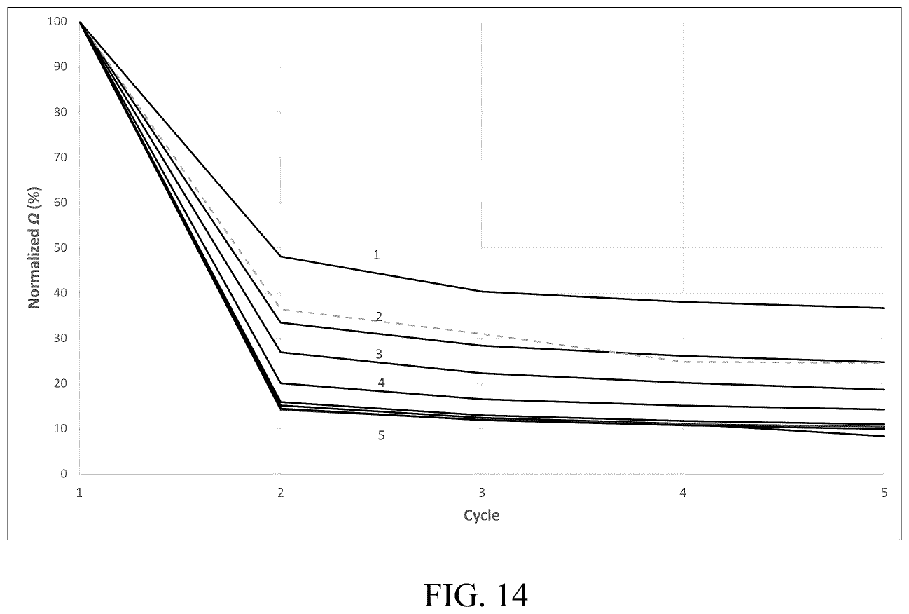

Foam that is subjected to compressive strain that extends far into the plateau region (FIG. 10) exhibit both elastic and plastic properties. It is the plastic deformation that accounts for the decrease in toughness (Ω) in repeated load/unload cycles (FIGS. 13 and 14). A large decrease in Ω was observed for all the samples after the first load/unload cycle with relatively small decreases with each subsequent cycle (FIG. 13). The decrease of Ω values was greatest for the paperboard composites. Even though the grid and cylinder foam composites with starch had much higher Ω in the first load cycle compared to EPS foam, the EPS foam had the highest Ω for the subsequent cycles (FIG. 13). This is due to the greater elastic behavior of the EPS foam relative to the paperboard composites.

A normalized view of the data illustrated the change in percent Ω for five consecutive load/unload cycles (FIG. 14). There was a large decrease in percent Ω after the first cycle for all the samples. The sample with the most elastic behavior (lowest decrease in percent Ω) was the FF−S sample followed by the FF+S and the EPS foam samples (FIG. 14). The paperboard composites exhibited the greatest amount of plastic behavior (greatest decrease in percent Ω (FIG. 14).

The relatively high elastic behavior of the fiber foam with or without starch indicates that these foams could be effective for internal packaging. However, due to their low CS, they may only be suitable for lightweight items. The paperboard composites have excellent CS but would not be expected to function as well as EPS foam in repeated major compression events due to their greater plastic behavior. Still, the results show that the fiber foam process for making composites with a wide range in CS and Ω values and low thermal conductivity is possible.

EPS foam is used in many humid and wet environments due to its moisture resistance. Moisture resistance can be an advantage in some packaging environments, but this property also contributes to the EPS foam's persistence in the environment. Biobased internal packaging materials that are moisture sensitive are gaining wider commercial acceptance. Such materials can be effective when a moisture barrier is included in the packaging. The fiber foams and composites described in the present study are moisture sensitive and would require a moisture barrier for use in humid or wet environments. However, these foams would also readily disperse and decompose in a composting facility or if spilled into the environment.

### Summary/Conclusions

Expanded polystyrene (EPS) foam and other petroleum-based plastic foam materials are used extensively as packaging to insulate and protect items during shipment. However, these materials have come under increasing scrutiny due to the volume of these materials that are sent to landfills and their environmental impact. This disclosure is directed to biodegradable insulative compression molded fiber foams and fiber foam paperboard composite materials. The “fiber foam composites” or “composites” discussed herein are primarily in the form of panels and incorporate one of three different types of reinforcing paperboard elements (angular, cylindrical, and grid).

The fiber foam panels discussed herein are formed in platen assemblies designed by the inventors. The panels are oven dried (80° C.). The inventors found that fiber foam panels that were allowed to dry in the platen assemblies had a more consistent thicknesses, less shrinkage/collapse, and were more likely to have smooth, flat finishes on both the upper and lower surfaces—as compared to fiber foam panels removed from the platen assembly before drying. Surprisingly, the drying time was similar for foam samples removed from the platen assemblies before drying or left inside the platen assemblies until after drying.

The average drying time was more than 2.5 hours longer for samples/panels containing starch. The dry density (Dd) of samples ranged from 33.1-64.9 k/m3 and thermal conductivity ranged from 0.039-0.049 W/mk. The fiber foam and composite panels without starch had lower flexural (σfM) and compressive (CS) strength compared to expanded polystyrene (EPS) foam—except for the grid composite panels. However, all the composites containing starch had greater σfM and flexural modulus (Ef) compared to EPS foam.

As best shown and described in Table 5, at 10% strain, the fiber foam composite materials with starch (FF+S) with cylindrical and grid reinforcing elements had significantly greater compressive strength (CS) and toughness (Ω) than EPS foam. The fiber foam composite material without starch (FF−S) with grid-type reinforcing elements also had greater CS and Ω than EPS foam. These materials (FF+S with cylindrical and grid-type reinforcing elements, and FF−S with grid-type reinforcing elements) meet the criteria for a “high strength fiber foam material/composite” as defined in this disclosure.

In conclusion, FF+S and FF−S have many useful properties but lack the CS and Ω performance of plastic foams (EPS) that are used extensively in internal packaging. However, the fiber foam formation process allows the embedment of reinforcing elements that can extend the range of CS and Ω even beyond that of commercial plastic foams while maintaining low density and thermal conductivity. The fiber foam paperboard composites containing starch were generally much stronger than composites without starch.

Of the samples tested, composites made with cylindrical paperboard elements had the best overall performance in terms of flexural and compressive properties while still having low density and thermal conductivity. The inventor's research demonstrated that the fiber foam process could provide a way to make composites (including composite panels) with the broad range in mechanical strength needed for many applications. Specifically, fiber foam products with embedded paperboard elements perform satisfactorily as a biodegradable and economical alternative to plastic foams.

For the foregoing reasons, it is clear that the subject matter described herein describes an innovative fiber foam packaging material that may be used in a wide variety of applications. The current system may be modified in multiple ways and applied in various technological applications. The disclosed method and apparatus may be modified and customized as required by a specific operation or application, and the individual components may be modified and defined, as required, to achieve the desired result. For example, although paper-based reinforcing means are specifically discussed, reinforcing means comprising biodegradable plastics may be used in some alternative embodiments.

Although the materials of construction are not described, they may include a variety of compositions consistent with the function described herein. Such variations are not to be regarded as a departure from the spirit and scope of this disclosure, and all such modifications as would be obvious to one skilled in the art are intended to be included within the scope of the following claims.

The amounts, percentages and ranges disclosed in this specification are not meant to be limiting, and increments between the recited amounts, percentages and ranges are specifically envisioned as part of the invention. All ranges and parameters disclosed herein are understood to encompass any and all sub-ranges subsumed therein, and every number between the endpoints. For example, a stated range of “1 to 10” should be considered to include any and all sub-ranges between (and inclusive of) the minimum value of 1 and the maximum value of 10 including all integer values and decimal values; that is, all sub-ranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions, and so forth as used in the specification and claims are to be understood as being modified in all instances by the implied term “about.” If the (stated or implied) term “about” precedes a numerically quantifiable measurement, that measurement is assumed to vary by as much as 10%. Essentially, as used herein, the term “about” refers to a quantity, level, value, or amount that varies by as much 10% to a reference quantity, level, value, or amount. Accordingly, unless otherwise indicated, the numerical properties set forth in the following specification and claims are approximations that may vary depending on the desired properties sought to be obtained in embodiments of the present invention.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

The term “consisting essentially of” or excludes additional method (or process) steps or composition components that substantially interfere with the intended activity of the method (or process) or composition, and can be readily determined by those skilled in the art (for example, from a consideration of this specification or practice of the invention disclosed herein). The invention illustratively disclosed herein suitably may be practiced in the absence of any element which is not specifically disclosed herein. The term “an effective amount” as applied to a component or a function excludes trace amounts of the component, or the presence of a component or a function in a form or a way that one of ordinary skill would consider not to have a material effect on an associated product or process.

What is claimed is:

1. A method of making a high strength biodegradable cellulosic fiber foam material, the method comprising the steps of:
(a) combining cellulosic fiber, a foaming agent, polyvinyl alcohol, and water, to create a biodegradable cellulosic fiber foam wet mix, the biodegradable cellulosic fiber foam wet mix (FF−S) having a wet density (Dw) of 100-140 kg/m³;
(b) adding starch to the cellulosic fiber foam wet mix to produce a fiber foam wet mix comprising about 0-6.0 weight percent starch;
(c) providing paper-based reinforcing means;
(d) adding the cellulosic fiber foam wet mix and the paper-based reinforcing means to a mold so that the cellulosic fiber foam wet mix binds with the paper-based reinforcing means;
(e) drying the cellulosic fiber foam wet mix to produce a high strength fiber foam composite material, the high strength fiber foam composite material having a compressive strength (CS) of at least about 72 kPa, and a toughness (Ω) of at least 0.34 Joules at 10% compressive strain.

2. The method of claim 1 wherein, in step (a), the biodegradable cellulosic fiber foam wet mix comprises about 12-19 weight percent cellulosic fiber.

3. The method of claim 1 wherein in step (a), the fiber comprises fiber derived from pulped wood fiber and has a fiber length from about 0.5 mm to 5 mm.

4. The method of claim 1 wherein, in step (a), biodegradable foam comprises about 6-9% polyvinyl alcohol, and the foaming agent comprises about 1%-6% sodium dodecyl sulfate.

5. The method of claim 4 wherein, the sodium dodecyl sulfate foaming agent produces a foam volume expansion of about 200-1200%.

6. The method of claim 1 wherein, in step (b), the starch comprises pregelatinized waxy corn starch powder.

7. The method of claim 1 wherein, in step (b), the biodegradable cellulosic fiber foam wet mix with starch (FF+S) has a wet density (Dw) of about 100-220 kg/m³;

8. The method of claim 1 wherein, after step (e), the dry high strength cellulosic fiber foam material comprises about 65-90% fiber by weight, about 6.5-9.5% polyvinyl alcohol, about 2-6% sodium dodecyl sulfate, and about 0.5-25% starch.

9. The method of claim 1 wherein, after step (e), the dry high strength cellulosic fiber foam material has a density that ranges from about 30-70 k/m³ and has a thermal conductivity of about 0.039-0.049 W/mk.

10. The method of claim 1 wherein, in step (e), the high strength cellulosic fiber foam composite material is formed into panels or other molded shapes.

11. The method of claim 1 wherein, after step (e), the high strength cellulosic fiber foam composite material has a CS and Ω at 10% compressive strain that is greater than or equal to expanded polystyrene (EPS) with a foam density range of 10-14 kg/m³.

12. The method of claim 1 wherein, when, in step (c), when the high strength cellulosic fiber foam wet mix has about 0 weight percent starch (FF−S) and a grid-type and/or cylindrical paper-based reinforcing means, after step (e), the high strength cellulosic fiber foam composite material has a greater CS and Ω, flexural strength (σ_{fM}), flexural modulus (E_{f}), and compressive modulus (E_{c}), than expanded polystyrene with a foam density range of 10-14 Kg/m³.

13. The method of claim 1 wherein, in step (c), the high strength cellulosic fiber foam wet mix has about 0.1-6 weight percent starch (FF+S), and a grid-type and/or cylindrical paper-based reinforcing means, after step (e), the high strength cellulosic fiber foam composite material has a greater CS and Ω, flexural strength (σ_{fM}), flexural modulus (E_{f}), and compressive modulus (E_{c}), than expanded polystyrene with a foam density range of 10-14 Kg/m³.

14. The method of claim 1 wherein, in step (c) the paper-based reinforcing means comprises rigid and semirigid reinforcing elements that may be comprised of paperboard, cardboard, boxboard, kraftboard, and/or other wood and/or paper fiber-based biodegradable/recyclable materials.

15. The method of claim 1 wherein, in step (c), the paper-based reinforceing means comprises a range of about 1 to 10 weight percent of the combination of the cellulosic fiber foam wet mix and the paper-based reinforcing means.

16. The method of claim 1 wherein in step (d), the mold cavity having top and bottom platens and being overfilled with the wet mixture of the high strength cellulosic fiber foam.

17. The method of claim 16 wherein faces of the top and bottom platens abut the high strength cellulosic fiber foam wet mix, the faces of the platens comprising a silk screen material.

18. The method of claim 17 wherein the high strength cellulosic fiber foam wet mix is dried at about 0-90° C. with the platens in place above and below the mold cavity.

19. A method of making a biodegradable high strength cellulosic fiber foam material, the method comprising the steps of:
(a) providing a high strength cellulosic fiber foam wet mix comprising cellulosic fiber, a sodium dodecyl sulfate foaming agent, polyvinyl alcohol fiber dispersant and binder, and starch;
(b) pouring the high strength cellulosic fiber foam wet mix into a mold so that the mold cavity is overfilled;
(c) either before or after pouring the wet mix into the mold, adding paper-based reinforcing means to the mold so that the wet mix binds with the paper-based reinforcing means;
(d) drying the wet mix so that the wet mix binds with the paper-based reinforcing means to form a high strength fiber foam composite material, the high strength fiber foam composite material having a compressive strength of at least about 72 kPa and a toughness of at least 0.34 Joules at 10% compressive strain.

20. The method of step (c) wherein the paper-based reinforcing means has a grid-type or cylindrical shape.
